(19) United States
(12) Patent Application Publication
(10) Pub. No.: US 2025/0199271 A1
(43) Pub. Date: Jun. 19, 2025

(54) IMAGING LENS SYSTEM

(71) Applicant: Samsung Electro-Mechanics Co., Ltd., Suwon-si (KR)

(72) Inventors: Tae Yeon LIM, Suwon-si (KR); Byung Hyun KIM, Suwon-si (KR); Yong Joo JO, Suwon-si (KR)

(73) Assignee: Samsung Electro-Mechanics Co., Ltd., Suwon-si (KR)

(21) Appl. No.: 18/960,360

(22) Filed: Nov. 26, 2024

(30) Foreign Application Priority Data
Dec. 19, 2023 (KR) 10-2023-0186290

(51) Int. Cl. G02B 13/00; G02B 9/62; G02B 9/64

(52) U.S. Cl. CPC G02B 13/0045; G02B 9/62; G02B 9/64

(57) ABSTRACT

An imaging lens system includes a first lens group including one or more lenses and an optical path converter; and a second lens group including one or more lenses and configured to be movable in an optical axis direction, wherein the first lens group and the second lens group are sequentially disposed in ascending numerical order along an optical axis of the imaging lens system from an object side of the imaging lens system toward an imaging plane of the imaging lens system, and the imaging lens system satisfies the conditional expression 1.50≤fPF/fPR≤6.50, where fPF is a focal length of a front lens of the first lens group disposed closest to an object side of the optical path converter, and fPR is a focal length of a rear lens of the first lens group disposed closest to an image side of the optical path converter.

### CROSS-REFERENCE TO RELATED APPLICATIONS

This application claims the benefit under 35 USC 119(a) of Korean Patent Application No. 10-2023-0186290 filed on Dec. 19, 2023, in the Korean Intellectual Property Office, the entire disclosure of which is incorporated herein by reference for all purposes.

### BACKGROUND

### 1. Field

The present disclosure relates to an imaging lens system configured to enable thinning and minimize resolution reduction due to changes in an angle of view.

### 2. Description of Related Art

Portable electronic devices include a camera module for capturing a still image or recording a moving image. For example, a camera module can be mounted on a mobile phone, laptop, a game console, or the other portable electronic device. Such portable electronic devices are generally manufactured in compact or small sizes to increase user convenience in terms of device portability. For example, a telephoto camera module mounted on the portable electronic device is configured to have an imaging lens system including an optical path converter. The camera module can be configured to produce images of constant quality regardless of the user's usage environment. For example, the camera module may include an image stabilization function. However, since the image stabilization function is performed by driving the entire imaging lens system or some lenses of the imaging lens system in a direction intersecting the optical axis, it may change the angle of view of the telephoto camera module or reduce the resolution of the telephoto camera module.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an imaging lens system includes a first lens group including one or more lenses and an optical path converter; and a second lens group including one or more lenses and configured to be movable in an optical axis direction, wherein the first lens group and the second lens group are sequentially disposed in ascending numerical order along an optical axis of the imaging lens system from an object side of the imaging lens system toward an imaging plane of the imaging lens system, and the imaging lens system satisfies the conditional expression 1.50≤fPF/fPR≤6.50, where fPF is a focal length of a front lens of the first lens group disposed closest to an object side of the optical path converter, and fPR is a focal length of a rear lens of the first lens group disposed closest to an image side of the optical path converter.

The front lens of the first lens group may have a convex object-side surface in a paraxial region thereof.

The rear lens of the first lens group may have a convex image-side surface in a paraxial region thereof.

A frontmost lens of the second lens group disposed closest to an image side of the rear lens of the first lens group may have a convex image-side surface in a paraxial region thereof.

A rearmost lens of the second lens group disposed closest to the imaging plane may have a concave object-side surface in a paraxial region thereof.

A rearmost lens of the second lens group disposed closest to the imaging plane may have a concave image-side surface in a paraxial region thereof.

The optical path converter may include a reflecting surface, and the imaging lens system may further satisfy the conditional expression 0.050≤ML/R1≤0.60, where ML is a distance along the optical axis from the reflecting surface of the optical path converter to an image-side surface of the rear lens of the first lens group, and R1 is a radius of curvature of an object-side surface of the front lens of the first lens group.

The optical path converter may include a reflecting surface, and the imaging lens system may further satisfy the conditional expression 0.2≤|ML/R4|≤1.0, where ML is a distance along the optical axis from the reflecting surface of the optical path converter to an image-side surface of the rear lens of the first lens group, and R4 is a radius of curvature of the image-side surface of the rear lens of the first lens group.

In another general aspect, an imaging lens system includes a first lens, an optical path converter, a second lens having a convex image-side surface in a paraxial region thereof, a third lens, a fourth lens, a fifth lens, and a sixth lens sequentially disposed in the order listed along an optical axis of the imaging lens system from an object side of the imaging lens system toward an imaging plane of the imaging lens system, wherein the imaging lens system satisfies the conditional expression 1.60<f1/f<3.60, where f is a focal length of the imaging lens system when the imaging lens system is focused on an object at infinity, and f1 is a focal length of the first lens.

The first lens may have a convex object-side surface in a paraxial region thereof.

The first lens may have a concave image-side surface in a paraxial region thereof.

The second lens may have a convex image-side surface in a paraxial region thereof.

The third lens may have a convex image-side surface in a paraxial region thereof.

The fourth lens may have a concave object-side surface in a paraxial region thereof.

The fourth lens may have a concave image-side surface in a paraxial region thereof.

The fifth lens may have a convex object-side surface in a paraxial region thereof.

In another general aspect, an imaging lens system includes a first lens having a positive refractive power and a convex object-side surface in a paraxial region thereof; an optical path converter; a second lens having a positive refractive power and a convex image-side surface in a paraxial region thereof; a third lens having a refractive power and a concave object-side surface in a paraxial region thereof; a fourth lens having a refractive power; a fifth lens having a refractive power; and a sixth lens having a refractive power and a concave image-side surface in a paraxial region thereof, wherein the first lens, the optical path converter, the second lens, the third lens, the fourth lens, the fifth lens, and the sixth lens are sequentially disposed in the order listed along an optical axis of the imaging lens system from an object side of the imaging lens system toward an imaging plane of the imaging lens system, the first to sixth lenses each have a single refractive index and are the only lenses having a refractive power in the imaging lens system, the third to sixth lenses are spaced apart from each other along the optical axis, the first lens, the optical path converter, and the second lens are included in a first lens group, and the third to sixth lenses are included in a second lens group configured to be movable along the optical axis to adjust a focus of the imaging lens system, or the third and fourth lenses are included in a second lens group configured to be movable along the optical axis to adjust the focus of the imaging lens system and the fifth and sixth lenses are included in a third lens group, or the third and fourth lenses are included in a second lens group and the fifth and sixth lenses are included in a third lens group configured to be movable along the optical axis to adjust the focus of the imaging lens system.

The second lens may have a flat object-side surface joined with an image-side surface of the optical path converter.

The first lens group may be configured to be rotatable about an axis perpendicular to the optical axis to perform image stabilization.

The optical path converter may include a reflecting surface, and the imaging lens system may satisfy the conditional expression 1.0≤G1L/Dp≤4.0, where G1L is a distance along the optical axis from the object-side surface of the first lens to the image-side surface of the second lens, and Dp is a diagonal length of the reflecting surface of the optical path converter.

The imaging lens system may satisfy the following expression 1.50≤fPF/fPR≤6.50, where fPF is a focal length of the first lens, and fPR is a focal length of the second lens.

The imaging lens system may satisfy the following expression 1.60<f1/f<3.60, where f is a focal length of the imaging lens system when the imaging lens system is focused on an object at infinity, and f1 is a focal length of the first lens.

In another general aspect, an imaging lens system may include a first lens having a positive refractive power and a convex object-side surface in a paraxial region thereof; an optical path converter; a second lens having a positive refractive power and a convex image-side surface in a paraxial region thereof; a third lens having a refractive power and a convex object-side surface in a paraxial region thereof; a fourth lens having a refractive power; a fifth lens having a refractive power; a sixth lens having a refractive power; and a seventh lens having a refractive power and a concave image-side surface in a paraxial region thereof, wherein the first lens, the optical path converter, the second lens, the third lens, the fourth lens, the fifth lens, the sixth lens, and the seventh lens are sequentially disposed in the order listed along an optical axis of the imaging lens system from an object side of the imaging lens system toward an imaging plane of the imaging lens system, the first to seventh lenses each have a single refractive index and are the only lenses having a refractive power in the imaging lens system, the third to seventh lenses are spaced apart from each other along the optical axis, the first lens, the optical path converter, and the second lens are included in a first lens group, and the third to seventh lenses are included in a second lens group configured to be movable along the optical axis to adjust a focus of the imaging lens system.

The second lens may have a flat object-side surface joined with an image-side surface of the optical path converter.

The first lens group may be configured to be rotatable about an axis perpendicular to the optical axis to perform image stabilization.

The optical path converter may include a reflecting surface, and the imaging lens system may satisfy the conditional expression 1.0≤G1L/Dp≤4.0, where G1L is a distance along the optical axis from the object-side surface of the first lens to the image-side surface of the second lens, and Dp is a diagonal length of the reflecting surface of the optical path converter.

The imaging lens system may satisfy the conditional expression 1.50≤fPF/fPR≤6.50, where fPF is a focal length of the first lens, and fPR is a focal length of the second lens.

The imaging lens system may satisfy the conditional expression 1.60<f1/f<3.60, where f is a focal length of the imaging lens system when the imaging lens system is focused on an object at infinity, and f1 is a focal length of the first lens.

Other features and aspects will be apparent from the following detailed description, the drawings, and the claims.

### BRIEF DESCRIPTION OF DRAWINGS

FIGS. 1 and 2 are configuration diagrams of an imaging lens system according to a first embodiment of the present disclosure.

FIG. 3 illustrates aberration characteristics of the imaging lens system illustrated in FIG. 1.

FIGS. 4 and 5 are configuration diagrams of an imaging lens system according to a second embodiment of the present disclosure.

FIG. 6. illustrates aberration characteristics of the imaging lens system illustrated in FIG. 4.

FIGS. 7 and 8 are configuration diagrams of an imaging lens system according to a third embodiment of the present disclosure.

FIG. 9 illustrates aberration characteristics of the imaging lens system illustrated in FIG. 7.

FIGS. 10 and 11 are configuration diagrams of an imaging lens system according to a fourth embodiment of the present disclosure.

FIG. 12 illustrates aberration characteristics of the imaging lens system illustrated in FIG. 10.

FIGS. 13 and 14 are configuration diagrams of an imaging lens system according to a fifth embodiment of the present disclosure.

FIG. 15 illustrates aberration characteristics of the imaging lens system illustrated in FIG. 13.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

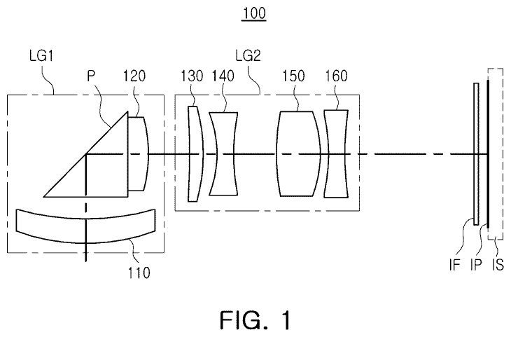

In the configuration diagrams in FIGS. 1-2, 4-5, 7-8, 10-11, and 13-14, the thicknesses, sizes, and shapes of the lenses may be somewhat exaggerated for illustration purposes. In addition, the spherical or aspherical shapes illustrated in the configuration diagrams are merely examples and are not limited to these shapes.

In this specification, a foremost lens or a first lens refers to a lens closest to an object (or subject), and a rearmost lens or a last lens refers to a lens closest to an imaging plane (or an image sensor). In the present specification, units of a radius of curvature, a thickness, a distance, TTL (a distance from an object-side surface of the first lens to the imaging plane), ImgHt (or Y, a height of the imaging plane), and a focal length are millimeters (mm).

A thickness of a lens, a gap between lenses, and TTL are measured along an optical axis.

Unless stated otherwise, a reference to a shape of a lens surface refers to a shape of a paraxial region of the lens surface. A paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

For example, a statement that an object-side surface of a lens is convex means that at least a paraxial region of the object-side surface of the lens is convex, and a statement that an image-side surface of the lens is concave means that at least a paraxial region of the image-side surface of the lens is concave. Therefore, even though the object-side surface of the lens may be described as being convex, the entire object-side surface of the lens may not be convex, and a peripheral region of the object-side surface of the lens may be concave. Also, even though the image-side surface of the lens may be described as being concave, the entire image-side surface of the lens may not be concave, and a peripheral region of the image-side surface of the lens may be convex.

An imaging lens system according to a first embodiment of the present disclosure may include two lens groups. For example, the imaging lens system according to the first embodiment may include a first lens group and a second lens group sequentially disposed in ascending numerical order along an optical axis of the imaging lens system from an object side of the imaging lens system toward an imaging plane of the imaging lens system. Furthermore, the number of lens groups constituting the imaging lens system according to the first embodiment may not be limited to two. For example, the imaging lens system according to the first embodiment may further include a third lens group disposed on the image side of the second lens group. The imaging lens system according to the first embodiment may include an optical path converter. For example, in the imaging lens system according to the first embodiment, the first lens group may include an optical path converter. The imaging lens system according to the first embodiment may include a lens group movable in an optical axis direction. For example, in the imaging lens system according to the first embodiment, the second lens group may be configured to be movable in the optical axis direction. The imaging lens system according to the first embodiment may satisfy a unique conditional expression. For example, the imaging lens system according to the first embodiment may satisfy the conditional expression 1.50≤fPF/fPR≤6.5, where fPF is a focal length of a front lens disposed closest to an object side of the optical path converter, and fPR is a focal length of a rear lens disposed closest to an image side of the optical path converter.

The imaging lens system according to the first embodiment may include one or more of the features listed below as needed.

For example, in the imaging lens system according to the first embodiment, the front lens disposed closest to the object side of the optical path converter may have a convex object-side surface in a paraxial region thereof.

As another example, in the imaging lens system according to the first embodiment, the rear lens disposed closest to the image side of the optical path converter may have a convex image-side surface in a paraxial region thereof.

As another example, in the imaging lens system according to the first embodiment, the lens disposed closest to the image side of the rear lens disposed closest to the image side of the optical path converter may have a convex image-side surface in a paraxial region thereof.

As another example, in the imaging lens system according to the first embodiment, the rearmost lens disposed closest to the imaging plane may have a concave object-side surface in a paraxial region thereof.

As another example, in the imaging lens system according to the first embodiment, the rearmost lens disposed closest to the imaging plane may have a concave image-side surface in a paraxial region thereof.

An imaging lens system according to a second embodiment of the present disclosure may include two lens groups. For example, the imaging lens system according to the second embodiment may include a first lens group and a second lens group sequentially disposed in ascending numerical order along an optical axis of the imaging lens system from an object side of the optical imaging system toward an imaging plane of the optical imaging system. However, the number of lens groups constituting the imaging lens system according to the second embodiment may not be limited to two. For example, the imaging lens system according to the second embodiment may further include a third lens group disposed on the image side of the second lens group. The imaging lens system according to the second embodiment may include an optical path converter. For example, in the imaging lens system according to the second embodiment, the first lens group may include an optical path converter. The imaging lens system according to the second embodiment may include a lens group movable in an optical axis direction. For example, in the imaging lens system according to the second embodiment, the second lens group may be configured to be movable in the optical axis direction. The imaging lens system according to the second embodiment may be configured with a predetermined number of lenses. For example, in the imaging lens system according to the second embodiment, there may be seven lenses constituting the first lens group and the second lens group.

An imaging lens system according to a third embodiment of the present disclosure may include two lens groups. For example, the imaging lens system according to the third embodiment may include a first lens group and a second lens group sequentially disposed in ascending numerical order along an optical axis of the imaging lens system from an object side of the optical imaging system toward an imaging plane of the optical imaging system. However, the number of lens groups in the imaging lens system according to the third embodiment may not be limited to two. For example, the imaging lens system according to the third embodiment may further include a third lens group disposed on the image side of the second lens group. The imaging lens system according to the third embodiment may include an optical path converter. For example, in the imaging lens system according to the third embodiment, the first lens group may include an optical path converter. The imaging lens system according to the third embodiment may include a lens group movable in an optical axis direction. For example, in the imaging lens system according to the third embodiment, the second lens group may be configured to be movable in the optical axis direction. The imaging lens system according to the third embodiment may include a plurality of lenses having a positive refractive power. For example, in the imaging lens system according to the third embodiment, a front lens disposed closest to the object side of the optical path converter and a rear lens disposed closest to the image side of the optical path converter may both have a positive refractive power.

An imaging lens system according to a fourth embodiment of the present disclosure may include two lens groups. For example, the imaging lens system according to the fourth embodiment may include a first lens group and a second lens group sequentially disposed in ascending numerical order along an optical axis of the imaging lens system from an object side of the optical imaging system toward an imaging plane of the optical imaging system. However, the number of lens groups constituting the imaging lens system according to the fourth embodiment may not be limited to two. As an example, the imaging lens system according to the fourth embodiment may further include a third lens group disposed on the image side of the second lens group. The imaging lens system according to the fourth embodiment may include an optical path converter. For example, in the imaging lens system according to the fourth embodiment, the first lens group may include an optical path converter. The imaging lens system according to the fourth embodiment may include a lens group movable in an optical axis direction. For example, in the imaging lens system according to the fourth embodiment of the present disclosure, the second lens group may be configured to be movable in the optical axis direction. The imaging lens system according to the fourth embodiment may include a joined lens. For example, in the imaging lens system according to the fourth embodiment, a rear lens disposed closest to the image side of the optical path converter may be joined to the optical path converter. For example, the image side of the optical path converter and the object side of the rear lens may be joined to each other.

An imaging lens system according to a fifth embodiment of the present disclosure may include two lens groups. For example, the imaging lens system according to the fifth embodiment may include a first lens group and a second lens group sequentially disposed in ascending numerical order along an optical axis of the imaging lens system from an object side of the optical imaging system toward an imaging plane of the optical imaging system. However, the number of lens groups constituting the imaging lens system according to the fifth embodiment may not be limited to two. For example, the imaging lens system according to the fifth embodiment may further include a third lens group disposed on the image side of the second lens group. The imaging lens system according to the fifth embodiment may include an optical path converter. For example, in the imaging lens system according to the fifth embodiment, an optical path converter may be disposed between the lenses of the first lens group. The imaging lens system according to the fifth embodiment may include a lens group movable in an optical axis direction. For example, in the imaging lens system according to the fifth embodiment, the second lens group may be configured to be movable in the optical axis direction. The imaging lens system according to the fifth embodiment may include a lens having a concave object-side surface in a paraxial region thereof. For example, the lens disposed closest to the object in the second lens group may have a concave object-side surface in a paraxial region thereof.

An imaging lens system according to a sixth embodiment of the present disclosure may include two lens groups. For example, the imaging lens system according to the sixth embodiment may include a first lens group and a second lens group sequentially disposed in ascending numerical order along an optical axis of the imaging lens system from an object side of the optical imaging system toward an imaging plane of the optical imaging system. However, the number of lens groups constituting the imaging lens system according to the sixth embodiment may not be limited to two. For example, the imaging lens system according to the sixth embodiment may further include a third lens group disposed on the image side of the second lens group. The imaging lens system according to the sixth embodiment may include an optical path converter. For example, in the imaging lens system according to the sixth embodiment, an optical path converter may be disposed between the lenses of the first lens group. The imaging lens system according to the sixth embodiment may include a lens group movable in an optical axis direction. For example, in the imaging lens system according to the sixth embodiment, the second lens group may be configured to be movable in the optical axis direction. The imaging lens system according to the sixth embodiment may include a lens having an Abbe number of a specific value. For example, the imaging lens system according to the sixth embodiment may include a lens having an Abbe number of 60 or more. As a specific example, a rear lens disposed closest to an image side of the optical path converter in the first lens group may have an Abbe number of 60 or more.

In the imaging lens system according to the sixth embodiment, since the rear lens disposed closest to the image side of the optical path converter has a high Abbe number, chromatic aberration caused by the refractive power of the rear lens may be minimized, which may be advantageous in realizing a high resolution.

An imaging lens system according to a seventh embodiment of the present disclosure may include a plurality of lens groups. As an example, the imaging lens system according to the seventh embodiment may include a first lens group and a second lens group sequentially disposed in ascending numerical order along an optical axis of the imaging lens system from an object side of the optical imaging system toward an imaging plane of the optical imaging system. As another example, the imaging lens system according to the seventh embodiment may include a first lens group, a second lens group, and a third lens group sequentially disposed in ascending numerical order along an optical axis of the imaging lens system from the object side of the optical imaging system toward an imaging plane of the optical imaging system. The imaging lens system according to the seventh embodiment may an include optical path converter. For example, in the imaging lens system according to the seventh embodiment, the optical path converter may be disposed between the lenses of the first lens group. The imaging lens system according to the seventh embodiment may satisfy any one or any combination of any two or more of the following conditional expressions:

$$1.5 \leq fPF / fPR \leq 6.50 \qquad ( Conditional Expression 1 )$$

$$0.3 \leq G 1 L / GL \leq 0. 80 \qquad ( Conditional Expression 2 )$$

$$0.3 \leq BFL / GL \leq 0. 80 \qquad ( Conditional Expression 3 )$$

$$1.2 \leq DG 12 / Gfm \leq 5.20 \qquad ( Conditional Expression 4 )$$

$$0.05 \leq ML / R 1 \leq 0.60 \qquad ( Conditional Expression 5 )$$

$$0.2 \leq \vert ML / R 4 \vert \leq 1. 0 \qquad ( Conditional Expression 6 )$$

$$1. \leq G 1 L / Dp \leq 4. 0 \qquad ( Conditional Expression 7 )$$

$$1. \leq Mf \leq 3.0 \qquad ( Conditional Expression 8 )$$

In the above conditional expressions, fPF is a focal length of a front lens disposed closest to an object side of the optical path converter in the front lens group, fPR is a focal length of a rear lens disposed closest to an image side of the optical path converter in the first lens group, G1L is a distance along the optical axis from an object-side surface of a foremost lens disposed closest to an object in the first lens group to an image-side surface of a lens disposed closest to an imaging plane in the first lens group, GL is a distance along the optical axis from the object-side surface of the foremost lens to an image-side surface of a rearmost lens disposed closest to the imaging plane, BFL is a distance along the optical axis from the image-side surface of the rearmost lens to the imaging plane, DG12 is a maximum distance along the optical axis from an image-side surface of a lens disposed closest to the second lens group in the first lens group to an object-side surface of a lens disposed closest to the first lens group in the second lens group, Gfm is a maximum moving distance along the optical axis of the second lens group or the third lens group between a position where the imaging lens system is focused on an object at infinity and a position where the imaging lens system is focused on an object at a near focus position of the imaging lens system, i.e., at a minimum focus distance of the imaging lens system, ML is a distance along the optical axis from a reflecting surface of the optical path converter to the image-side surface of the lens disposed closest to the imaging plane in the first lens group, R1 is a radius of curvature of the object-side surface of the front lens disposed closest to the object side of the optical path converter in the first lens group, R4 is a radius of curvature of the image-side surface of the rear lens disposed closest to the image side of the optical path converter in the first lens group, Dp is a diagonal length of the reflecting surface of the optical path converter, and Mf is a magnification of the imaging lens system when the imaging lens system is focused on an object at infinity.

An imaging lens system satisfying Conditional Expression 1 may maximize an image stabilization effect. For example, an imaging lens system falling outside the numerical range of Conditional Expression 1 may greatly increase aberrations and a resolution may be reduced due to an excessively long focal length of the front lens disposed closest to the object side of the optical path converter in the first lens group or an excessively long focal length of the rear lens disposed closest to the image side of the optical path converter in the first lens group.

An imaging lens system satisfying Conditional Expression 2 may be advantageous for miniaturization. For example, in an imaging lens system falling below the lower limit of Conditional Expression 2, it may be difficult to secure a space where the optical path converter may be disposed, and an imaging lens system exceeding the upper limit of Conditional Expression 2 may have ta problem of increasing a size or a volume of the camera module.

An imaging lens system satisfying Conditional Expression 3 may be advantageous for miniaturization and imaging plane curvature correction. For example, an imaging lens system falling below the lower limit of Conditional Expression 3 may be advantageous for imaging plane curvature correction, but disadvantageous for miniaturization of the imaging lens system and the camera module as an aperture of the lens becomes large, and an imaging lens system exceeding the upper limit of Conditional Expression 3 may have a problem of degradation in a resolution due to a significant increase in an imaging plane curvature.

An imaging lens system satisfying Conditional Expression 4 may be advantageous in securing a driving space of an image stabilization lens group (the first lens group) and a movement space for a focus adjustment lens group (the second lens group or the third lens group). For example, an imaging lens system falling below the lower limit of Conditional Expression 4 may not secure a sufficient driving space for the first lens group for image stabilization of the camera module, and an imaging lens system exceeding the upper limit of Conditional Expression 4 may not secure a sufficient movement space for the second lens group (or the third lens group) for focus adjustment of the camera module. Furthermore, in an imaging lens system falling outside the numerical range of Conditional Expression 4, aberrations are likely to occur due to the refractive power of the second lens group being low.

An imaging lens system satisfying Conditional Expressions 5 and 6 may minimize changes in a resolution due to camera module image stabilization. For example, an imaging lens system satisfying the numerical ranges of Conditional Expressions 5 and 6 may maintain a resolution stably as the optical path of the first lens group does not change significantly when the first lens group is driven for image stabilization.

Conditional Expression 7 is a condition for limiting the size of the optical path converter and the size of the imaging lens system. For example, an imaging lens system falling below the lower limit of Conditional Expression 7 may prevent miniaturization of the imaging lens system because the thickness of the first lens group including the optical path converter increases, and an imaging lens system exceeding the upper limit of Conditional Expression 7 may have difficulty securing the performance of the imaging lens system as the optical path converter becomes too small.

An imaging lens system satisfying Conditional Expression 8 may implement a constant resolution. For example, an imaging lens system falling below the lower limit of Conditional Expression 8 means an optical axis of the first lens group deviates significantly from the optical axis of the second lens group, and an imaging lens system exceeding the upper limit of Conditional Expression 8 means that the optical axis of the second lens group deviates significantly from the optical axis of the first lens group. In other words, an imaging lens system falling outside the numerical range of Conditional Expression 8 may have a problem of significant changes in resolution as the first lens group is driven for image stabilization.

An imaging lens system according to an eighth embodiment of the present disclosure may include a plurality of lenses. For example, the imaging lens system according to the eighth embodiment may include a first lens, an optical path converter, a second lens, a third lens, a fourth lens, a fifth lens, and a sixth lens sequentially disposed in the order listed along an optical axis of the imaging lens system from an object side of the optical imaging system toward an imaging plane of the optical imaging system. However, the number of lenses constituting the imaging lens system according to the eighth embodiment may not limited to six lenses. For example, the imaging lens system according to the eighth aspect may further include a seventh lens disposed on an image side of the sixth lens. The imaging lens system according to the eighth aspect may satisfy a unique conditional expression. For example, the imaging lens system according to the eighth aspect may satisfy the conditional expression 1.60<f1/f<3.60, where f is a focal length of the imaging lens system when imaging lens system is focused on an object at infinity, and f1 is a focal length of the first lens.

An imaging lens system according to a ninth embodiment may include a plurality of lenses sequentially disposed along an optical axis of the imaging lens system from an object side of the optical imaging system toward an imaging plane of the optical imaging system, and may satisfy any one or any combination of any two or more of the conditional expressions listed below. For example, the imaging lens system according to the ninth embodiment may include a first lens, a second lens, a third lens, a fourth lens, a fifth lens, and a sixth lens sequentially disposed in ascending numerical order along an optical axis of the imaging lens system from an object side of the optical imaging system toward an imaging plane of the optical imaging system, or may include a first lens, a second lens, a third lens, a fourth lens, a fifth lens, a sixth lens, and a seventh lens sequentially disposed in ascending numerical order along an optical axis of the imaging lens system from an object side of the optical imaging system toward an imaging plane of the optical imaging system, and may satisfy any one or any combination of any two or more of the following conditional expressions:

$$1.6 < f 1 / f < 3.60 \qquad ( Conditional Expression 9 )$$

$$0.4 < f 3 / f > 1.20 \qquad ( Conditional Expression 10 )$$

$$- 0.4 \; 0 < f 4 / f < - 0.20 \qquad ( Conditional Expression 11 )$$

$$0.2 \text{<\textbar} f 6 / f \vert < 0. 60 \qquad ( Conditional Expression 12 )$$

$$1.6 < f 1 / f 2 < 5.20 \qquad ( Conditional Expression 13 )$$

$$0.3 < BFL / f < 0.60 \qquad ( Conditional Expression 14 )$$

$$0.2 < D 12 / f < 0.40 \qquad ( Conditional Expression 15 )$$

$$- 2.8 < f 3 / fR < - 0.80 \qquad ( Conditional Expression 16 )$$

In the above conditional expressions, f is a focal length of the imaging lens system when the imaging lens system is focused on an object at infinity, f1 is a focal length of the first lens, f2 is a focal length of the second lens, f3 is a focal length of the third lens, f4 is a focal length of the fourth lens, f6 is a focal length of the sixth lens, BFL is a distance along the optical axis from an image-side surface of a rearmost lens disposed closest to the imaging plane in the imaging lens system to the imaging plane, D12 is a distance along the optical axis from an image-side surface of the first lens to an object-side surface of the second lens, and fR is a focal length of the rearmost lens disposed closest to the imaging plane in the imaging lens system.

Conditional Expressions 9 to 13 and 16 are conditions for realizing a high resolution of the imaging lens system. For example, an imaging lens system satisfying the numerical ranges of Conditional Expressions 9 to 13 and 16 may be advantageous in minimizing various aberrations caused by the first to fourth lenses and the sixth lens.

Conditional Expression 14 may be a condition for a telephoto characteristic and miniaturization of the imaging lens system. For example, an imaging lens system falling outside the numerical range of Conditional Expression 14 is difficult to miniaturize or implement a telephoto characteristic.

Conditional Expression 15 may be a condition for the configuration of the optical path converter and the telephoto characteristic of the imaging lens system. For example, it is difficult to arrange an optical path converter for an imaging lens system falling below the lower limit of Conditional Expression 15, and it is difficult to implement a telephoto characteristic for an imaging lens system exceeding the upper limit of Conditional Expression 15.

An imaging lens system according to the present disclosure may include one or more lenses having the following characteristics as needed. As an example, the imaging lens system according to the first embodiment may include one of the first to seventh lenses having the following characteristics. As another example, the imaging lens system according to the second to seventh embodiments may include one or more of the first to seventh lenses having the following characteristics. However, the imaging lens system according to the above-described embodiments may not necessarily include a lens having he following features. The characteristics of the first to seventh lenses will be described below.

The first lens may have a refractive power. For example, the first lens may have a positive refractive power. The first lens may have a meniscus shape. For example, the first lens may have a convex object-side surface in a paraxial region thereof. As another example, the first lens may have a concave image-side surface in a paraxial region thereof. The first lens may include a spherical or aspherical surface. For example, both surfaces of the first lens may be aspherical. The first lens may be made of a material having a high light transmittance and an excellent processability. For example, the first lens may be made of a plastic material or a glass material. The first lens may have a predetermined refractive index. For example, the refractive index of the first lens may be greater than 1.5. As a specific example, the refractive index of the first lens may be greater than 1.50 and less than 1.6. The first lens may have a predetermined Abbe number. For example, the Abbe number of the first lens may be 50 or more.

The second lens may have a refractive power. For example, the second lens may have a positive refractive power. The second lens may have a convex shape on one surface. For example, the second lens may have a convex image-side surface in a paraxial region thereof. The second lens may include a flat surface, a spherical surface, or an aspherical surface. For example, the object-side surface of the second lens may be flat. As another example, the image-side surface of the second lens may be spherical. The second lens may be made of a material having a high light transmittance and an excellent processability. For example, the second lens may be made of a plastic material or a glass material. The second lens may have a predetermined refractive index. For example, the refractive index of the second lens may be less than 1.5. The second lens may have a predetermined Abbe number. For example, the Abbe number of the second lens may be 60 or more. As another example, the Abbe number of the second lens may be 80 or more.

The third lens may have a refractive power. For example, the third lens may have a positive refractive power. The third lens may have a convex shape on one surface. For example, the third lens may have a convex image-side surface in a paraxial region thereof. The third lens may include a spherical or aspherical surface. For example, both surfaces of the third lens may be aspherical. The third lens may be made of a material having a high light transmittance and an excellent processability. For example, the third lens may be made of a plastic material. The third lens may have a predetermined refractive index. For example, the refractive index of the third lens may be greater than 1.5. The third lens may have a predetermined Abbe number. For example, the Abbe number of the third lens may be greater than 50.

The fourth lens may have a refractive power. For example, the fourth lens may have a negative refractive power. The fourth lens may have a concave shape on one surface. As an example, the fourth lens may have a concave object-side surface in a paraxial region thereof. As another example, the fourth lens may have a concave image-side surface in a paraxial region thereof. The fourth lens may include a spherical or aspherical surface. For example, both surfaces of the fourth lens may be aspherical. The fourth lens may be made of a material having a high light transmittance and an excellent processability. For example, the fourth lens may be made of a plastic material. The fourth lens may have a predetermined refractive index. As an example, the refractive index of the fourth lens may be greater than 1.6. The fourth lens may have a predetermined Abbe number. For example, the Abbe number of the fourth lens may be greater than 20. As a specific example, the Abbe number of the fourth lens may be greater than 20 and less than 30.

The fifth lens may have a refractive power. For example, the fifth lens may have a positive refractive power or a negative refractive power. The fifth lens may have a convex shape on one surface. As an example, the fifth lens may have a convex object-side surface in a paraxial region thereof. The fifth lens may include a spherical or aspherical surface. For example, both surfaces of the fifth lens may be aspherical. The fifth lens may be made of a material having a high light transmittance and an excellent processability. For example, the fifth lens may be made of a plastic material. The fifth lens may have a predetermined refractive index. As an example, the refractive index of the fifth lens may be greater than 1.5.

The sixth lens may have a refractive power. For example, the sixth lens may have a positive refractive power or a negative refractive power. The sixth lens may have a convex or concave shape on one surface. As an example, the sixth lens having a positive refractive power may have a convex object-side surface in a paraxial region thereof or a convex image-side surface in a paraxial region thereof. As another example, the sixth lens having a negative refractive power may have a concave object-side surface in a paraxial region thereof or a concave image-side surface in a paraxial region thereof. The sixth lens may include a spherical or aspherical surface. For example, both surfaces of the sixth lens may be aspherical. The sixth lens may be made of a material having a high light transmittance and an excellent processability. For example, the sixth lens may be made of a plastic material. The sixth lens may have a predetermined refractive index. As an example, the refractive index of the sixth lens may be greater than 1.6. The sixth lens may have a predetermined Abbe number. For example, the Abbe number of the sixth lens may be greater than 20. As a specific example, the Abbe number of the sixth lens may be greater than 20 and less than 30.

The seventh lens may have a refractive power. For example, the seventh lens may have a negative refractive power. The seventh lens may have a concave shape on one surface. As an example, the seventh lens may have a concave image-side surface in a paraxial region thereof. The seventh lens may include a spherical or aspherical surface. For example, both surfaces of the seventh lens may be aspherical. The seventh lens may be made of a material having a high light transmittance and an excellent processability. For example, the seventh lens may be made of a plastic material. The seventh lens may have a predetermined refractive index. As an example, the refractive index of the seventh lens may be greater than 1.6. The seventh lens may have a predetermined Abbe number. For example, the Abbe number of the seventh lens may be greater than 20. As a specific example, the Abbe number of the seventh lens may be greater than 20 and less than 30.

As described above, the first to seventh lenses may include a spherical surface or an aspherical surface. When the first to seventh lenses include an aspherical surface, the aspherical surface of the corresponding lens may be expressed by Equation 1 below.

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{`16} + {Hr}^{18} + {Jr}^{20} \qquad ( 1 )$$

In Equation 1, c is a curvature of the lens surface and is equal to a reciprocal of a radius of curvature of the lens surface at an optical axis of the lens surface, k is a conic constant, and r is a distance from any point on the aspherical surface of the lens to the optical axis. In addition, constants A to H and J are aspherical surface coefficients. Z (also known as sag) is a distance in a direction parallel to an optical axis direction between the point on the aspherical surface of the lens at the distance r from the optical axis of the aspherical surface to a tangential plane perpendicular to the optical axis and intersecting a vertex of the aspherical surface.

An imaging lens system according to the above-described embodiment or the above-described form may further include a stop and a filter. The stop may be disposed between the third and fourth lenses. The filter may be disposed between the rearmost lens (the sixth or seventh lens) and the imaging plane. The filter may be configured to block light of specific wavelengths. For reference, the filter described in the present specification is configured to block infrared rays, but the wavelengths of light blocked by the filter are not limited to infrared rays.

Hereinafter, specific embodiments of the present disclosure will be described in detail based on the accompanying drawings.

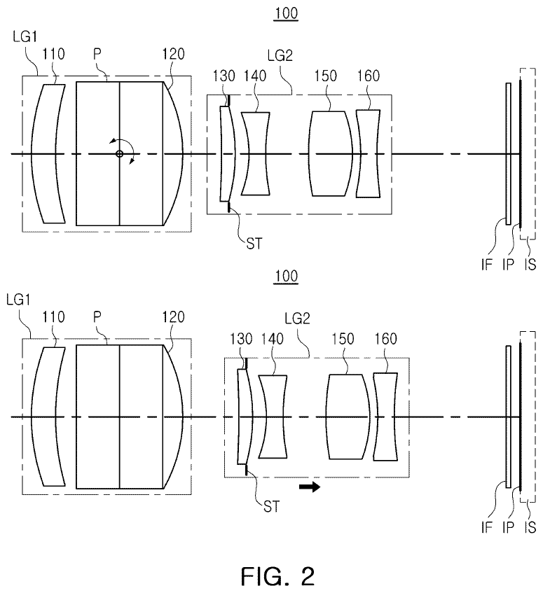

FIGS. 1 and 2 are configuration diagrams of an imaging lens system according to a first embodiment of the present disclosure.

Referring to FIG. 1, an imaging lens system 100 may include a plurality of lens groups. For example, the imaging lens system 100 may include a first lens group (LG1) and a second lens group (LG2). The first lens group LG1 and the second lens group LG2 may be sequentially disposed in ascending numerical order along an optical axis of the imaging lens system 100 from an object side of the imaging lens system 100 toward an imaging plane (IP) of the imaging lens system 100. The first lens group (LG1) and the second lens group (LG2) may include one or more lenses. For example, the first lens group (LG1) may include two lenses, and the second lens group (LG2) may include four lenses. The imaging lens system 100 may include an optical path converter. As an example, the imaging lens system 100 may include a prism (P) disposed between the two lenses of the first lens group (LG1). For reference, in the present embodiment, a prism (P) is illustrated as a type of optical path converter, but it may also be possible to change the optical path converter to a reflector.

The first lens group (LG1) may include a first lens 110 and a second lens 120. The first lens 110 may have a positive refractive power, a convex object-side surface in a paraxial region thereof, and a concave image-side surface in a paraxial region thereof. The second lens 120 may have a positive refractive power and a convex image-side surface in a paraxial region thereof. The second lens 120 may be disposed very close to the image-side surface of the prism (P). For example, the object-side surface of the second lens 120 may be flat so it may be bonded to the image-side surface of the prism (P). As another example, the second lens 120 may be integrally formed with the image-side surface of the prism (P).

The second lens group (LG2) may include a third lens 130, a fourth lens 140, a fifth lens 150, and a sixth lens 160. The third lens 130 may have a positive refractive power, a concave object-side surface in a paraxial region thereof, and a convex image-side surface in a paraxial region thereof. The fourth lens 140 may have a negative refractive power, a concave object-side surface in a paraxial region thereof, and a concave image-side surface in a paraxial region thereof. The fifth lens 150 may have a positive refractive power, a convex object-side surface in a paraxial region thereof, and a convex image-side surface in a paraxial region thereof. The sixth lens 160 may have a negative refractive power, a concave object-side surface in a paraxial region thereof, and a concave image-side surface in a paraxial region thereof.

The imaging lens system 100 may be mounted in a camera module capable of image stabilization and focus adjustment. For example, in the imaging lens system 100, the first lens group LG1 may be rotated about an axis intersecting the optical axis to perform image stabilization as illustrated in FIG. 2, and the second lens group LG2 may be moved in the optical axis direction to perform focus adjustment as illustrated in FIG. 2. In the present embodiment, a change in a focal length (f) of the imaging lens system 100 due to the movement of the second lens group (LG2) may be very slight. Therefore, the imaging lens system 100 according to the present embodiment may implement a resolution of a substantially constant quality even if the focus is adjusted by moving the second lens group (LG2).

The imaging lens system 100 may further include other elements in addition to the first lens 110 to the sixth lens 160. For example, the imaging lens system 100 may further include a stop (ST), a filter (IF), and an imaging plane (IP). The stop (ST) may be disposed between the third lens 130 and the fourth lens 140. The filter (IF) may be disposed between the sixth lens 160 and the imaging plane (IP). The imaging plane (IP) may be located at a position where light incident through the first lens 110 to the sixth lens 160 forms an image. For example, the imaging plane (IP) may be located on one surface of an image sensor (IS) of a camera module or on a lens element disposed inside the image sensor (IS).

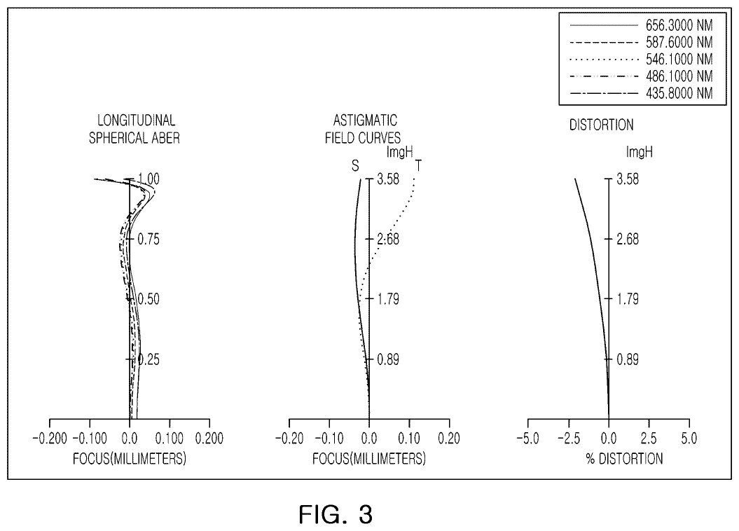

FIG. 3 illustrates aberration characteristics of the imaging lens system 100 according to the present embodiment.

Tables 1 and 2 below list lens characteristics of the imaging lens system 100 according to the present embodiment, and Table 3 below lists aspheric values of the imaging lens system 100 according to the present embodiment. Table 2 lists lens characteristics when the imaging lens system 100 is focused on an object at infinity, and when the imaging lens system 100 is focused on an object at a near focus position of the imaging lens system 100, i.e., at a minimum focus distance of the imaging lens system 100.

TABLE 1

| Surface | | Radius of | Thickness/ | Refractive | Abbe | Effective |
|---|---|---|---|---|---|---|
| No. | Component | Curvature | Distance | Index | No. | Radius |
| S0 | Object | Infinity | D0 | | | |
| S1 | 1st Lens | 8.7709 | 1.2000 | 1.5349 | 55.735 | 3.3000 |
| S2 | | 13.7889 | 1.0000 | | | 3.2057 |
| S3 | Prism | Infinity | 2.1000 | 1.9229 | 20.880 | 3.2016 |
| S4 | | Infinity | 2.1000 | 1.9229 | 20.880 | 3.1939 |
| S5 | 2nd Lens | Infinity | 0.9547 | 1.4970 | 81.607 | 3.1862 |
| S6 | | −7.2689 | D1 | | | 3.1852 |
| S7 | 3rd Lens | −26.3374 | 0.6775 | 1.5349 | 55.735 | 2.3000 |
| S8 | Stop | −6.6516 | 0.6491 | | | 2.2159 |
| S9 | 4th Lens | −5.2305 | 0.8000 | 1.6144 | 25.936 | 2.0139 |
| S10 | | 10.2061 | 2.0918 | | | 1.9102 |
| S11 | 5th Lens | 10.3027 | 2.1000 | 1.6510 | 20.870 | 2.0000 |
| S12 | | −5.4522 | 0.3844 | | | 2.0642 |
| S13 | 6th Lens | −11.3719 | 0.8000 | 1.6534 | 20.694 | 2.0000 |
| S14 | | 8.3092 | D2 | | | 2.1228 |
| S15 | Filter | Infinity | 0.2100 | 1.5168 | 64.197 | 3.4260 |
| S16 | | Infinity | D3 | | | 3.4557 |
| S17 | Imaging | Infinity | D4 | | | Ray Cut |
| | Plane | | | | | |

TABLE 2

| | Object at | Object at Near |
|---|---|---|
| | Infinity | Focus Position |
| D0 | Infinity | 300 |
| D1 | 2.00306 | 2.83725 |
| D2 | 6.22817 | 5.39398 |
| D3 | 0.50134 | 0.54697 |
| D4 | −0.00134 | −0.04697 |
| f | 18.61152 | 17.50609 |
| Dp | 2.96985 | 2.96985 |
| FOV | 11.10109 | 10.67406 |
| f number | 2.91441 | 2.83557 |
| TTL | 23.79880 | 23.79880 |

TABLE 3

| Surface | | | | | |
|---|---|---|---|---|---|
| No. | k | A | B | C | D |
| S1 | −10 | 0.001634361 | −9.88574E−05 | 3.16747E−06 | −1.62555E−07 |
| S2 | −10 | 0.000929702 | −5.6119E−06 | −7.72632E−07 | −8.22999E−08 |
| S7 | −10 | 0.000419628 | 0.000348873 | −0.00010993 | 1.53061E−05 |
| S8 | −10 | −0.001349675 | 0.000565729 | −0.000186989 | 2.74588E−05 |
| S9 | −10 | −0.00657121 | 0.00137365 | −0.000285171 | 3.80915E−05 |
| S10 | −10 | −0.001713145 | 0.000389147 | −0.000104104 | 2.1576E−05 |
| S11 | −10 | −0.001296889 | 0.000386551 | −0.000183593 | 1.67936E−05 |
| S12 | −10 | −0.002035698 | 0.000547763 | −0.000290848 | 3.00754E−05 |
| S13 | −10 | 0.001053306 | −0.001244564 | 0.000138174 | −1.0145E−06 |
| S14 | −10 | −0.003907337 | −0.000234206 | 0.000120913 | −9.72911E−06 |

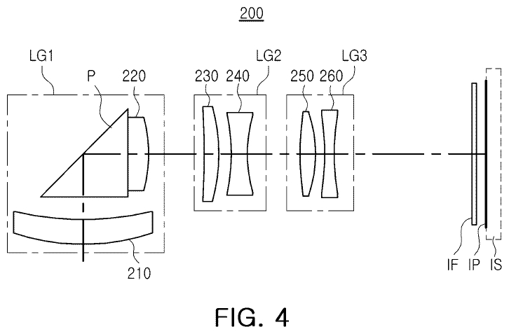

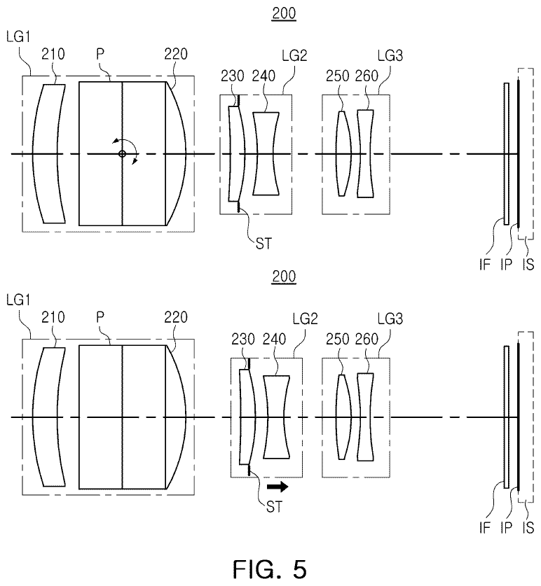

FIGS. 4 and 5 are configuration diagrams of an imaging lens system according to a second embodiment of the present disclosure.

Referring to FIG. 4, an imaging lens system 200 may include a plurality of lens groups. For example, the imaging lens system 200 may include a first lens group (LG1), a second lens group (LG2), and a third lens group (LG3). The first lens group (LG1), the second lens group (LG2), and the third lens group (LG3) may be sequentially disposed in ascending numerical order along an optical axis of the imaging lens system 200 from an object side of the imaging lens system 200 toward an imaging plane (IP) of the imaging lens system 200. The first lens group (LG1) to the third lens group (LG3) may include one or more lenses. For example, the first lens group (LG1) may include two lenses, the second lens group (LG2) may include two lenses, and the third lens group (LG3) may include two lenses. The imaging lens system 200 may include an optical path converter. As an example, the imaging lens system 200 may include a prism (P) disposed between the two lenses of the first lens group (LG1). For reference, in the present embodiment, a prism (P) is illustrated as a type of optical path converter, but it may also be possible to change the optical path converter to a reflector.

The first lens group (LG1) may include a first lens 210 and a second lens 220. The first lens 210 may have a positive refractive power, a convex object-side surface in a paraxial region thereof, and a concave image-side surface in a paraxial region thereof. The second lens 220 may have a positive refractive power and a convex image-side surface in a paraxial region thereof. The second lens 220 may be disposed very close to the image-side surface of the prism (P). For example, the object-side surface of the second lens 220 may be flat so it may be bonded to the image-side surface of the prism (P). As another example, the second lens 220 may be integrally formed with the image-side surface of the prism (P).

The second lens group (LG2) may include a third lens 230 and a fourth lens 240. The third lens 230 may have a positive refractive power, a concave object-side surface in a paraxial region thereof, and a convex image-side surface in a paraxial region thereof. The fourth lens 240 may have a negative refractive power, a concave object-side surface in a paraxial region thereof, and a concave image-side surface in a paraxial region thereof.

The third lens group (LG3) may include a fifth lens 250 and a sixth lens 260. The fifth lens 250 may have a positive refractive power, a convex object-side surface in a paraxial region thereof, and a convex image-side surface in a paraxial region thereof. The sixth lens 260 may have a negative refractive power, a concave object-side surface in a paraxial region thereof, and a concave image-side surface in a paraxial region thereof.

The imaging lens system 200 may be mounted in a camera module capable of image stabilization and focus adjustment. For example, in the imaging lens system 200, the first lens group (LG1) may be rotated about an axis intersecting the optical axis to perform image stabilization as illustrated in FIG. 5, and the second lens group (LG2) may be moved in the optical axis direction to perform focus adjustment as illustrated in FIG. 5. In the present embodiment, a change in a focal length (f) of the imaging lens system 200 due to the movement of the second lens group (LG2) may be very slight. Therefore, the imaging lens system 200 according to the present embodiment may implement a resolution of a substantially constant quality even if the focus is adjusted by moving the second lens group (LG2).

The imaging lens system 200 may further include other elements in addition to the first lens 210 to the sixth lens 260. For example, the imaging lens system 200 may further include a stop (ST), a filter (IF), and an imaging plane (IP). The stop (ST) may be disposed between the third lens 230 and the fourth lens 240. The filter (IF) may be disposed between the sixth lens 260 and the imaging plane (IP). The imaging plane (IP) may be located at a position where light incident through the first 210 to the sixth lens 260 forms an image. For example, the imaging plane (IP) may be located on one surface of an image sensor (IS) of the camera module or on a lens element disposed inside the image sensor (IS).

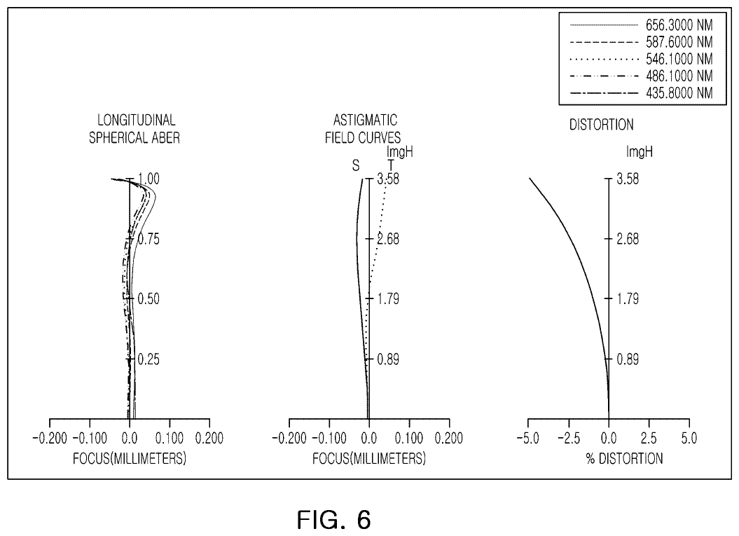

FIG. 6 illustrates aberration characteristics of the imaging lens system 200 according to the present embodiment.

Tables 4 and 5 below list lens characteristics of the imaging lens system 200 according to the present embodiment, and Table 6 below lists aspheric values of the imaging lens system 200 according to the present embodiment. Table 5 lists lens characteristics when the imaging lens system 200 is focused on an object at infinity, and when the imaging lens system 200 is focused on an object at a near focus position of the imaging lens system 200, i.e., at a minimum focus distance of the imaging lens system 200.

TABLE 4

| Surface | | Radius of | Thickness/ | Refractive | Abbe | Effective |
|---|---|---|---|---|---|---|
| No. | Component | Curvature | Distance | Index | No. | Radius |
| S0 | Object | Infinity | D0 | | | |
| S1 | 1st Lens | 9.6952 | 1.2000 | 1.5349 | 55.735 | 3.3000 |
| S2 | | 17.1954 | 1.0000 | | | 3.2224 |
| S3 | Prism | Infinity | 2.1000 | 1.9229 | 20.880 | 3.2155 |
| S4 | | Infinity | 2.1000 | 1.9229 | 20.880 | 3.2042 |
| S5 | 2nd Lens | Infinity | 0.9772 | 1.4970 | 81.607 | 3.1929 |
| S6 | | −7.4463 | D1 | | | 3.1911 |
| S7 | 3rd Lens | −32.4282 | 0.7205 | 1.5349 | 55.735 | 2.3000 |
| S8 | Stop | −7.4960 | 0.5972 | | | 2.2020 |
| S9 | 4th Lens | −10.0333 | 0.7269 | 1.6144 | 25.936 | 1.9813 |
| S10 | | 5.5828 | D2 | | | 1.8237 |
| S11 | 5th Lens | 10.2480 | 0.7421 | 1.6392 | 23.491 | 2.0000 |
| S12 | | −5.3738 | 0.4203 | | | 2.0234 |
| S13 | 6th Lens | −11.1630 | 0.4500 | 1.6392 | 23.491 | 2.0000 |
| S14 | | 8.4935 | D3 | | | 2.0831 |
| S15 | Filter | Infinity | 0.2100 | 1.5168 | 64.197 | 3.4354 |
| S16 | | Infinity | D4 | | | 3.4647 |
| S17 | Imaging | Infinity | D5 | | | Ray Cut |
| | Plane | | | | | |

TABLE 5

| | Object at | Object at Near |
|---|---|---|
| | Infinity | Focus Position |
| D0 | Infinity | 300 |
| D1 | 2.14374 | 2.67193 |
| D2 | 3.06556 | 2.53738 |
| D3 | 6.44336 | 6.44336 |
| D4 | 0.49566 | 0.51659 |
| D5 | 0.00434 | −0.01659 |
| f | 18.61121 | 17.74058 |
| Dp | 2.96985 | 2.96985 |
| FOV | 11.42710 | 10.77930 |
| f number | 2.88651 | 2.86237 |
| TTL | 23.39685 | 23.39685 |

TABLE 6

| Surface | | | | | |
|---|---|---|---|---|---|
| No. | k | A | B | C | D |
| S1 | −10 | 0.001167814 | −6.52963E−05 | 1.12934E−06 | −1.12642E−07 |
| S2 | −10 | 0.000735222 | 1.90498E−06 | −1.54245E−06 | −5.99445E−08 |
| S7 | −10 | 0.000732182 | 0.000341913 | −0.000105478 | 1.38825E−05 |
| S8 | −10 | −0.000213642 | 0.000364236 | −0.000151929 | 2.40644E−05 |
| S9 | −10 | −0.001339182 | 0.000229399 | −0.000125317 | 2.71742E−05 |
| S10 | −10 | 0.00516683 | −0.000476644 | 1.39106E−05 | 1.35259E−05 |
| S11 | −10 | −0.001237676 | 0.000382881 | −0.00018625 | 1.64607E−05 |
| S12 | −10 | −0.002476046 | 0.000676932 | −0.000324339 | 3.50095E−05 |
| S13 | −10 | 0.001638214 | −0.001198376 | 0.000114919 | 5.85891E−06 |
| S14 | −10 | −0.004712534 | −0.000264366 | 9.31888E−05 | −5.35475E−06 |

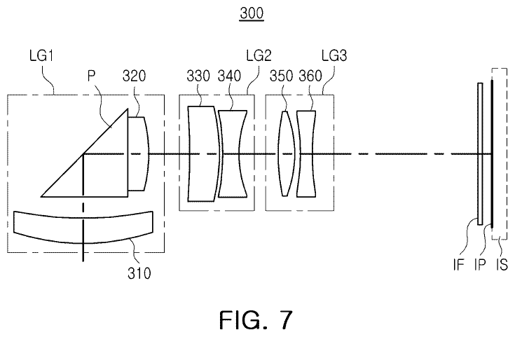

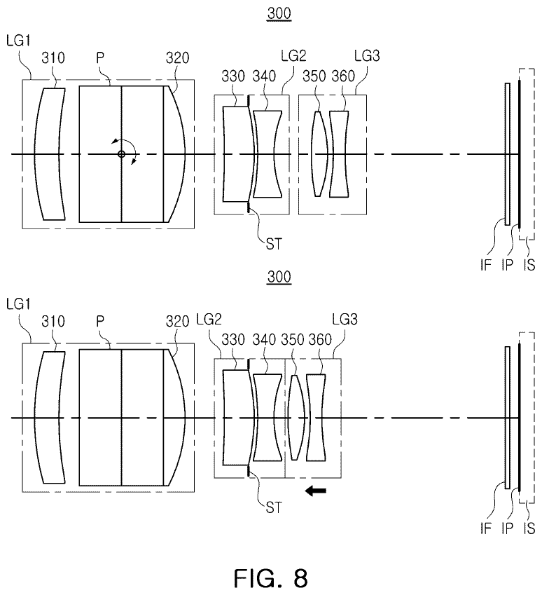

FIGS. 7 and 8 are configuration diagrams of an imaging lens system according to a third embodiment.

Referring to FIG. 7, an imaging lens system 300 may include a plurality of lens groups. For example, the imaging lens system 300 may include a first lens group (LG1), a second lens group (LG2), and a third lens group (LG3). The first lens group (LG1), the second lens group (LG2), and the third lens group (LG3) may be sequentially disposed in ascending numerical order along an optical axis of the imaging lens system 300 from an object side of the imaging lens system 300 toward an imaging plane (IP) of the imaging lens system 300. The first lens group (LG1) to the third lens group (LG3) may include one or more lenses. For example, the first lens group (LG1) may include two lenses, the second lens group (LG2) may include two lenses, and the third lens group (LG3) may include two lenses. The imaging lens system 300 may include an optical path converter. As an example, the imaging lens system 300 may include a prism (P) disposed between the two lenses of the first lens group (LG1). For reference, in the present embodiment, a prism (P) is illustrated as a type of optical path converter, but it may also be possible to change the optical path converter to a reflector.

The first lens group (LG1) may include a first lens 310 and a second lens 320. The first lens 310 may have a positive refractive power, a convex object-side surface in a paraxial region thereof, and a concave image-side surface in a paraxial region thereof. The second lens 320 may have a positive refractive power and a convex image-side surface in a paraxial region thereof. The second lens 320 may be disposed very close to the image-side surface of the prism (P). For example, the object-side surface of the second lens 320 may be flat so it may be bonded to the image-side surface of the prism (P). As another example, the second lens 320 may be integrally formed with the image-side surface of the prism (P).

The second lens group (LG2) may include a third lens 330 and a fourth lens 340. The third lens 330 may have a positive refractive power, a concave object-side surface in a paraxial region thereof, and a convex image-side surface in a paraxial region thereof. The fourth lens 340 may have a negative refractive power, a concave object-side surface in a paraxial region thereof, and a concave image-side surface in a paraxial region thereof.

The third lens group (LG3) may include a fifth lens 350 and a sixth lens 360. The fifth lens 350 may have a positive refractive power, a convex object-side surface in a paraxial region thereof, and a convex image-side surface in a paraxial region thereof. The sixth lens 360 may have a negative refractive power, a concave object-side surface in a paraxial region thereof, and a concave image-side surface in a paraxial region thereof.

The imaging lens system 300 may be mounted in a camera module capable of image stabilization and focus adjustment. For example, in the imaging lens system 300, the first lens group (LG1) may be rotated about an axis intersecting the optical axis to perform image stabilization as illustrated in FIG. 8, and the third lens group (LG3) may be moved in the optical axis direction to perform focus adjustment as illustrated in FIG. 8. In the present embodiment, a change in a focal length (f) of the imaging lens system 300 due to the movement of the third lens group (LG3) may be very slight. Therefore, the imaging lens system 300 according to the present embodiment may implement a resolution of a substantially constant quality even if the focus is adjusted by moving the third lens group (LG3).

The imaging lens system 300 may further include other elements in addition to the first lens 310 to the sixth lens 360. For example, the imaging lens system 300 may further include a stop (ST), a filter (IF), and an imaging plane (IP). The stop (ST) may be disposed between the third lens 330 and the fourth lens 340. The filter (IF) may be disposed between the sixth lens 360 and the imaging plane (IP). The imaging plane (IP) may be located at a position where light incident through the first lens 310 to the sixth lens 360 forms an image. For example, the imaging plane (IP) may be located on one surface of an image sensor (IS) of the camera module or on a lens element disposed inside the image sensor (IS).

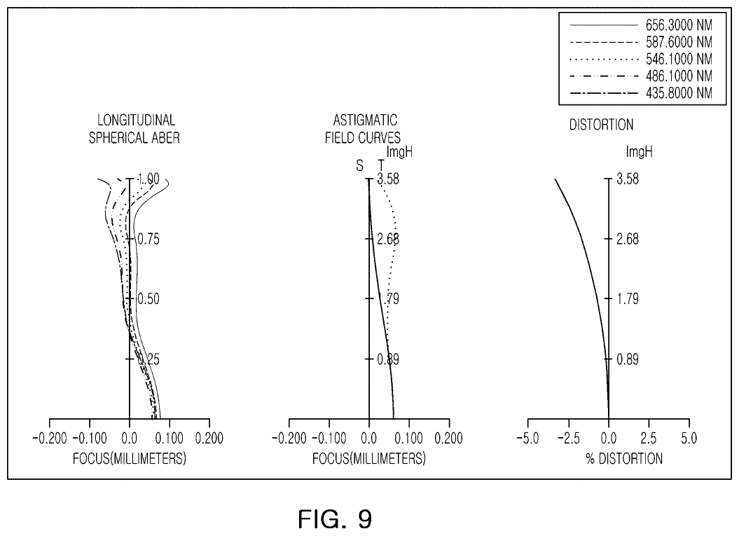

FIG. 9 illustrates aberration characteristics of the imaging lens system 300 according to the present embodiment.

Tables 7 and 8 below list lens characteristics of the imaging lens system 300 according to the present embodiment, and Table 9 below lists aspheric values of the imaging lens system 300 according to the present embodiment. Table 8 lists lens characteristics when the imaging lens system 300 is focused on an object at infinity, and when the imaging lens system 300 is focused on an object at a near focus position of the imaging lens system 300, i.e., at a minimum focus distance of the imaging lens system 300.

TABLE 7

| Surface | | Radius of | Thickness/ | Refractive | Abbe | Effective |
|---|---|---|---|---|---|---|
| No. | Component | Curvature | Distance | Index | No. | Radius |
| S0 | Object | Infinity | D0 | | | |
| S1 | 1st Lens | 9.4584 | 1.2000 | 1.5349 | 55.735 | 3.3000 |
| S2 | | 17.1705 | 1.0000 | | | 3.2076 |
| S3 | Prism | Infinity | 2.1000 | 1.9229 | 20.880 | 3.1696 |
| S4 | | Infinity | 2.1000 | 1.9229 | 20.880 | 3.1111 |
| S5 | 2nd Lens | Infinity | 1.0767 | 1.4970 | 81.607 | 3.0577 |
| S6 | | −7.4899 | 1.9974 | | | 3.0455 |
| S7 | 3rd Lens | −26.8456 | 1.4219 | 1.5349 | 55.735 | 2.3000 |
| S8 | Stop | −7.3260 | 0.1540 | | | 2.1340 |
| S9 | 4th Lens | −9.2288 | 0.8000 | 1.6144 | 25.936 | 2.0912 |
| S10 | | 5.1703 | D1 | | | 1.9449 |
| S11 | 5th Lens | 8.6026 | 0.8167 | 1.6392 | 23.491 | 2.0000 |
| S12 | | −4.8771 | 0.2839 | | | 2.0214 |
| S13 | 6th Lens | −10.0584 | 0.5588 | 1.6392 | 23.491 | 2.0000 |
| S14 | | 9.1214 | D2 | | | 2.0753 |
| S15 | Filter | Infinity | 0.2100 | 1.5168 | 64.197 | 3.4689 |
| S16 | | Infinity | D3 | | | 3.4934 |
| S17 | Imaging | Infinity | D4 | | | Ray Cut |
| | Plane | | | | | |

TABLE 8

| | Object at | Object at Near |
|---|---|---|
| | Infinity | Focus Position |
| D0 | Infinity | 300 |
| D1 | 1.87423 | 0.67004 |
| D2 | 7.94483 | 9.14901 |
| D3 | 0.56199 | 0.58142 |
| D4 | −0.06199 | −0.08142 |
| f | 18.61076 | 18.36615 |
| Dp | 2.96985 | 2.96985 |
| FOV | 11.29553 | 10.03714 |
| f number | 2.86697 | 3.10441 |
| TTL | 24.03836 | 24.03836 |

TABLE 9

| Surface | | | | | |
|---|---|---|---|---|---|
| No. | k | A | B | C | D |
| S1 | −10 | 0.001305927 | −7.91474E−05 | 3.28347E−06 | −2.61694E−07 |
| S2 | −10 | 0.000662844 | 2.76979E−06 | −1.84363E−06 | −1.19914E−07 |
| S7 | −10 | 0.000145855 | 9.98939E−05 | −4.5874E−05 | 2.3176E−06 |
| S8 | −10 | 0.000177912 | 0.000465808 | −0.000213706 | 3.7101E−05 |
| S9 | −10 | −0.00095494 | 0.000466252 | −0.000112388 | 3.42246E−05 |
| S10 | −10 | 0.005935739 | −0.000833526 | 0.000124841 | 2.35793E−06 |
| S11 | −10 | −0.001448407 | 0.000453162 | −0.000186703 | 1.30865E−05 |
| S12 | −10 | −0.004618933 | 0.001321183 | −0.000411197 | 4.34333E−05 |
| S13 | −10 | 0.002066196 | −0.001241864 | 0.000122071 | 1.40503E−05 |
| S14 | −10 | −0.005014422 | −0.000135444 | 4.59018E−05 | 1.88076E−06 |

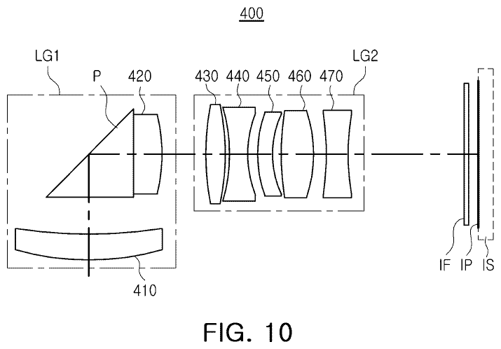

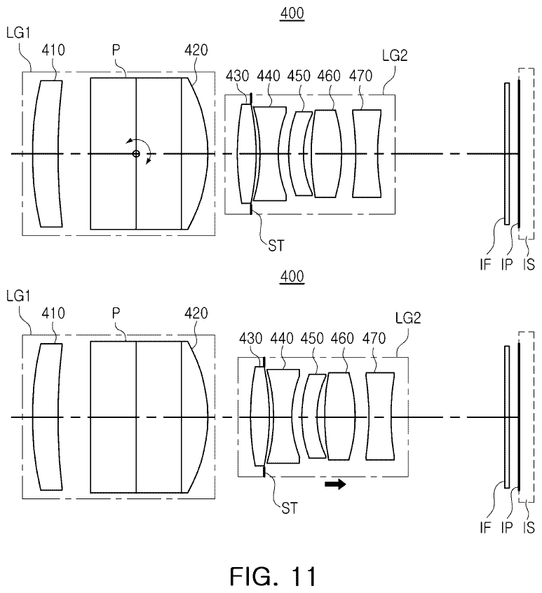

FIGS. 10 and 11 are configuration diagrams of an imaging lens system according to a fourth embodiment of the present disclosure.

Referring to FIG. 10, an imaging lens system 400 may include a plurality of lens groups. For example, the imaging lens system 400 may include a first lens group (LG1) and a second lens group (LG2). The first lens group (LG1) and the second lens group (LG2) may be sequentially disposed in ascending numerical order along an optical axis of the imaging lens system 400 from an object side of the imaging lens system 400 toward an imaging plane (IP) of the imaging lens system 400. The first lens group (LG1) and the second lens group (LG2) may include one or more lenses. For example, the first lens group (LG1) may include two lenses, and the second lens group (LG2) may include five lenses. The imaging lens system 400 may include an optical path converter. As an example, the imaging lens system 400 may include a prism (P) disposed between the two lenses of the first lens group (LG1). For reference, in the present embodiment, a prism (P) is illustrated as a type of optical path converter, but it may also be possible to change the optical path converter to a reflector.

The first lens group (LG1) may include a first lens 410 and a second lens 420. The first lens 410 may have a positive refractive power, a convex object-side surface in a paraxial region thereof, and a concave image-side surface in a paraxial region thereof. The second lens 420 may have a positive refractive power and a convex image-side surface in a paraxial region thereof. The second lens 420 may be disposed very close to the image-side surface of the prism (P). For example, the object-side surface of the second lens 420 may be flat in order to be bonded to the image-side surface of the prism (P). As another example, the second lens 420 may be integrally formed with the image-side surface of the prism (P).

The second lens group (LG2) may include a third lens 430, a fourth lens 440, a fifth lens 450, a sixth lens 460, and a seventh lens 470. The third lens 430 may have a positive refractive power, a convex object-side surface in a paraxial region thereof, and a convex image-side surface in a paraxial region thereof. The fourth lens 440 may have a negative refractive power, a concave object-side surface in a paraxial region thereof, and a concave image-side surface in a paraxial region thereof. The fifth lens 450 may have a negative refractive power, a convex object-side surface in a paraxial region thereof, and a concave image-side surface in a paraxial region thereof. The sixth lens 460 may have a positive refractive power, a convex object-side surface in a paraxial region thereof, and a convex image-side surface in a paraxial region thereof. The seventh lens 470 may have a negative refractive power, a concave object-side surface in a paraxial region thereof, and a concave image-side surface in a paraxial region thereof.

The imaging lens system 400 may be mounted in a camera module capable of image stabilization and focus adjustment. For example, in the imaging lens system 400, the first lens group (LG1) may be rotated about an axis intersecting the optical axis to perform image stabilization as illustrated in FIG. 11, and the second lens group (LG2) may be moved in the optical axis direction to perform focus adjustment as illustrated in FIG. 11. In the present embodiment, a change in a focal length (f) of the imaging lens system 400 due to the movement of the second lens group (LG2) may be very slight. Therefore, the imaging lens system 400 according to the present embodiment may implement a resolution of a substantially constant quality even if the focus is adjusted by moving the second lens group (LG2).

The imaging lens system 400 may further include other elements in addition to the first lens 410 to the seventh lens 470. For example, the imaging lens system 400 may further include a stop (ST), a filter (IF), and an imaging plane (IP). The stop (ST) may be disposed between the third lens 430 and the fourth lens 440. The filter (IF) may be disposed between the seventh lens 470 and the imaging plane (IP). The imaging plane (IP) may be located at a position where light incident through the first lens 410 to the seventh lens 470 forms an image. For example, the imaging plane (IP) may be located on one surface of an image sensor (IS) of the camera module or on a lens element disposed inside the image sensor (IS).

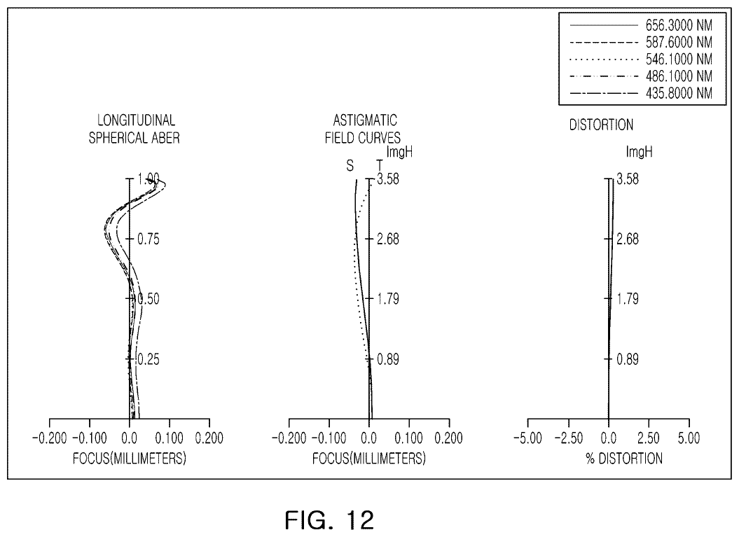

FIG. 12 illustrates aberration characteristics of the imaging lens system 400 according to the present embodiment.

Tables 10 and 11 below list lens characteristics of the imaging lens system 400 according to the present embodiment, and Table 12 below lists aspheric values of the imaging lens system 400 according to the present embodiment. Table 11 lists lens characteristics when the imaging lens system 400 is focused on an object at infinity, and when the imaging lens system 400 is focused on an object at a near focus position of the imaging lens system 400, i.e., at a minimum focus distance of the imaging lens system 400.

TABLE 10

| Surface | | Radius of | Thickness/ | Refractive | Abbe | Effective |
|---|---|---|---|---|---|---|
| No. | Component | Curvature | Distance | Index | No. | Radius |
| S0 | Object | Infinity | D0 | | | |
| S1 | 1st Lens | 14.1732 | 1.2000 | 1.5349 | 55.735 | 3.3500 |
| S2 | | 66.4955 | 1.5000 | | | 3.2700 |
| S3 | Prism | Infinity | 2.1000 | 1.9229 | 20.880 | 3.2481 |
| S4 | | Infinity | 2.1000 | 1.9229 | 20.880 | 3.2301 |
| S5 | 2nd Lens | Infinity | 1.2757 | 1.4970 | 81.607 | 3.2120 |
| S6 | | −7.0384 | D1 | | | 3.2065 |
| S7 | 3rd Lens | 15.6819 | 0.8613 | 1.5349 | 55.735 | 2.3000 |
| S8 | Stop | −11.1642 | 0.1848 | | | 2.1791 |
| S9 | 4th Lens | −7.7385 | 0.8365 | 1.6144 | 25.936 | 2.1302 |
| S10 | | 4.9802 | 0.4360 | | | 1.8933 |
| S11 | 5th Lens | 4.4164 | 0.6914 | 1.5440 | 55.990 | 1.9177 |
| S12 | | 3.5736 | 0.3877 | | | 1.8855 |
| S13 | 6th Lens | 11.4387 | 1.4500 | 1.6608 | 20.377 | 1.9000 |
| S14 | | −6.2365 | 0.6175 | | | 1.9909 |
| S15 | 7th Lens | −19.9576 | 1.0000 | 1.6392 | 23.491 | 1.9433 |
| S16 | | 8.6923 | D2 | | | 2.0000 |
| S17 | Filter | Infinity | 0.2100 | 1.5168 | 64.197 | 3.4254 |
| S18 | | Infinity | D3 | | | 3.4571 |
| S19 | Imaging | Infinity | D4 | | | Ray Cut |
| | Plane | | | | | |

TABLE 11

| | Object at | Object at Near |
|---|---|---|
| | Infinity | Focus Position |
| D0 | Infinity | 300 |
| D1 | 1.35000 | 1.99326 |
| D2 | 6.27128 | 5.62802 |
| D3 | 0.50721 | 0.57804 |
| D4 | −0.00721 | −0.07804 |
| f | 18.61080 | 17.16046 |
| Dp | 2.96985 | 2.96985 |
| FOV | 10.85176 | 10.55991 |
| f number | 2.92038 | 2.77078 |
| TTL | 22.97232 | 22.97232 |

TABLE 12

| Surface | | | | | |
|---|---|---|---|---|---|
| No. | k | A | B | C | D |
| S1 | −10 | 0.000301531 | 5.89617E−07 | 1.50451E−06 | −7.52916E−08 |
| S2 | −10 | 0.00047867 | 2.86625E−05 | 1.9324E−06 | −8.71395E−08 |
| S7 | −10 | 0.001477817 | 7.19897E−05 | −2.6085E−05 | 2.66372E−06 |
| S8 | −10 | 0.000143242 | 0.000125476 | −0.000200358 | 3.15237E−05 |
| S9 | −10 | −0.003019465 | 0.000597011 | −0.000212248 | 3.23541E−05 |
| S10 | −10 | 0.00870147 | −0.001080681 | 0.000143469 | 1.5381E−05 |
| S11 | −10 | 0.006231347 | −0.003031763 | 0.000582211 | −5.05436E−05 |
| S12 | −10 | 0.016854321 | −0.006480143 | 0.001431153 | −0.000154432 |
| S13 | −10 | 0.000613892 | 0.000547168 | −0.000210925 | 1.36488E−05 |
| S14 | −10 | −0.001366973 | 8.68917E−05 | −0.000248964 | 3.35657E−05 |
| S15 | −10 | 0.000229951 | −0.001349072 | 0.000127956 | −1.96671E−07 |
| S16 | −10 | −0.00300445 | −0.000415128 | 0.000105702 | −7.5412E−06 |

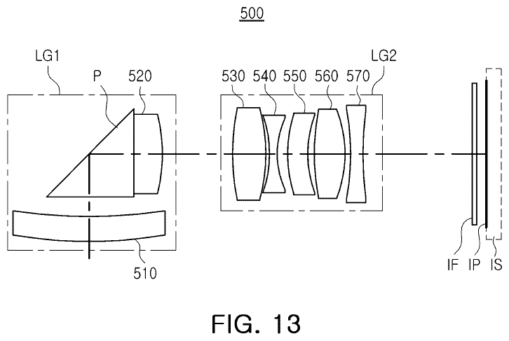

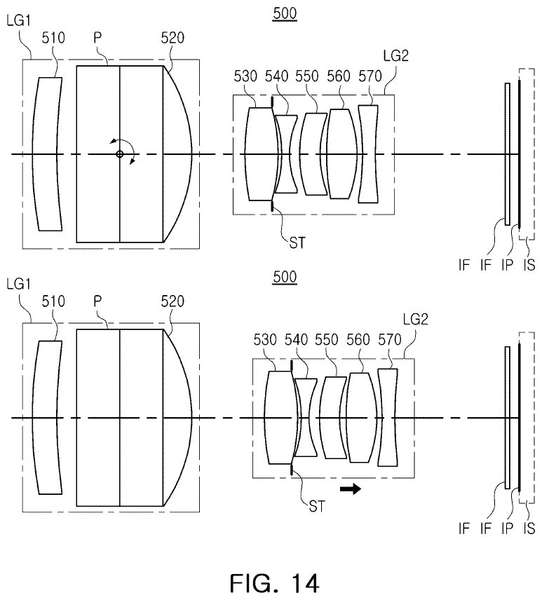

FIGS. 13 and 14 are configuration diagrams of an imaging lens system according to a fifth embodiment of the present disclosure.

Referring to FIG. 13, an imaging lens system 500 may include a plurality of lens groups. For example, the imaging lens system 500 may include a first lens group (LG1) and a second lens group (LG2). The first lens group (LG1) and the second lens group (LG2) may be sequentially disposed in ascending numerical order along an optical axis of the imaging lens system 500 from an object side of the imaging lens system 500 toward an imaging plane (IP) of the imaging lens system 500. The first lens group (LG1) and the second lens group (LG2) may include one or more lenses. For example, the first lens group (LG1) may include two lenses, and the second lens group (LG2) may include five lenses. The imaging lens system 500 may include an optical path converter. As an example, the imaging lens system 500 may include a prism (P) disposed between the two lenses of the first lens group (LG1). For reference, in the present embodiment, a prism (P) is illustrated as a type of optical path converter, but it may also be possible to change the optical path converter to a reflector.

The first lens group (LG1) may include a first lens 510 and a second lens 520. The first lens 510 may have a positive refractive power, a convex object-side surface in a paraxial region thereof, and a concave image-side surface in a paraxial region thereof. The second lens 520 may have a positive refractive power and a convex image-side surface in a paraxial region thereof. The second lens 520 may be disposed very close to the image-side surface of the prism (P). For example, the object-side surface of the second lens 520 may be flat so it may be bonded to the image-side surface of the prism (P). As another example, the second lens 520 may be integrally formed with the image-side surface of the prism (P).

The second lens group (LG2) may include a third lens 530, a fourth lens 540, a fifth lens 550, a sixth lens 560, and a seventh lens 570. The third lens 530 may a have positive refractive power, a convex object-side surface in a paraxial region thereof, and a convex image-side surface in a paraxial region thereof. The fourth lens 540 may include a negative refractive power, a concave object-side surface in a paraxial region thereof, and a concave image-side surface in a paraxial region thereof. The fifth lens 550 may include a negative refractive power, a convex object-side surface in a paraxial region thereof, and a concave image-side surface in a paraxial region thereof. The sixth lens 560 may include a positive refractive power, a convex object-side surface in a paraxial region thereof, and a convex image-side surface in a paraxial region thereof. The seventh lens 570 may have a negative refractive power, a concave object-side surface in a paraxial region thereof, and a concave image-side surface in a paraxial region thereof.

The imaging lens system 500 may be mounted in a camera module capable of image stabilization and focus adjustment. For example, in the imaging lens system 500, the first lens group (LG1) may be rotated about an axis intersecting the optical axis to perform image stabilization as illustrated in FIG. 14, and the second lens group (LG2) may be moved in the optical axis direction to perform focus adjustment as illustrated in FIG. 14. In the present embodiment, change in a focal length (f) of the imaging lens system 500 due to the movement of the second lens group (LG2) may be very slight. Therefore, the imaging lens system 500 according to the present embodiment may implement a resolution of a substantially constant quality even if the focus is adjusted by moving the second lens group (LG2).

The imaging lens system 500 may further include other elements in addition to the first lens 510 to the seventh lens 570. For example, the imaging lens system 500 may further include a stop (ST), a filter (IF), and an imaging plane (IP). The stop (ST) may be disposed between the third lens 530 and the fourth lens 540. The filter (IF) may be disposed between the seventh lens 570 and the imaging plane (IP). The imaging plane (IP) may be located at a position where light incident through the first lens 510 to the seventh lens 570 forms an image. For example, the imaging plane (IP) may be located on one surface of an image sensor (IS) of the camera module or on a lens element disposed inside the image sensor (IS).

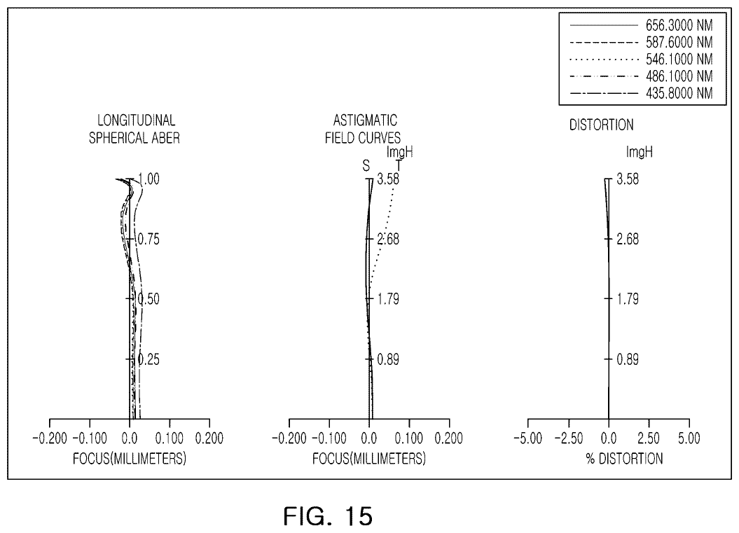

FIG. 15 illustrates aberration characteristics of the imaging lens system 500 according to the present embodiment.

Tables 13 and 14 below list lens characteristics of the imaging lens system 500 according to the present embodiment, and Table 15 below lists aspheric values of the imaging lens system 500 according to the present embodiment. Table 14 lists lens characteristics when the imaging lens system 500 is focused on an object at infinity, and when the imaging lens system 150 is focused on an object at a near focus position of the imaging lens system 500, i.e., at a minimum focus distance of the imaging lens system 500.

TABLE 13

| Surface | | Radius of | Thickness/ | Refractive | Abbe | Effective |
|---|---|---|---|---|---|---|
| No. | Component | Curvature | Distance | Index | No. | Radius |
| S0 | Object | Infinity | D0 | | | |
| S1 | 1st Lens | 20.3498 | 1.2000 | 1.5349 | 55.735 | 3.8003 |
| S2 | | 55.9690 | 1.0000 | | | 3.7681 |
| S3 | Prism | Infinity | 2.1000 | 1.9229 | 20.880 | 3.8033 |
| S4 | | Infinity | 2.1000 | 1.9229 | 20.880 | 3.8531 |
| S5 | 2nd Lens | Infinity | 1.5000 | 1.4970 | 81.607 | 3.9028 |
| S6 | | −7.0418 | D1 | | | 3.9123 |
| S7 | 3rd Lens | 11.3895 | 1.6511 | 1.5349 | 55.735 | 2.2950 |
| S8 | Stop | −7.8573 | 0.1961 | | | 1.9965 |
| S9 | 4th Lens | −6.0392 | 0.3898 | 1.6144 | 25.936 | 1.9372 |
| S10 | | 4.2764 | 0.5152 | | | 1.7645 |
| S11 | 5th Lens | 5.5988 | 0.9835 | 1.5440 | 55.990 | 1.8109 |
| S12 | | 4.0973 | 0.3223 | | | 2.0054 |
| S13 | 6th Lens | 9.0564 | 1.5515 | 1.6608 | 20.377 | 2.0601 |
| S14 | | −5.5606 | 0.2659 | | | 2.2088 |
| S15 | 7th Lens | −15.3091 | 0.6000 | 1.6392 | 23.491 | 2.1972 |
| S16 | | 10.0643 | D2 | | | 2.3838 |
| S17 | Filter | Infinity | 0.2100 | 1.5168 | 64.197 | 3.4762 |
| S18 | | Infinity | D3 | | | 3.5026 |
| S19 | Imaging | Infinity | D4 | | | Ray Cut |
| | Plane | | | | | |

TABLE 14

| | Object at | Object at Near |
|---|---|---|
| | Infinity | Focus Position |
| D0 | Infinity | 300 |
| D1 | 2.50000 | 3.44852 |
| D2 | 6.33853 | 5.38807 |
| D3 | 0.50895 | 0.51090 |
| D4 | −0.00895 | −0.01090 |
| f | 18.61081 | 17.15039 |
| Dp | 2.96985 | 2.96985 |
| FOV | 10.91238 | 10.53593 |
| f number | 2.87859 | 2.64071 |
| TTL | 23.92396 | 23.92202 |

TABLE 15

| Surface | | | | | |
|---|---|---|---|---|---|
| No. | k | A | B | C | D |
| S1 | −10 | −0.000140439 | −1.69886E−06 | −4.19081E−07 | −3.43153E−08 |
| S2 | −10 | 0.000447409 | 1.76035E−05 | −6.78439E−07 | −1.35401E−08 |
| S7 | −10 | 0.001599408 | 0.0001687 | −7.04047E−05 | 5.99077E−06 |
| S8 | −10 | −0.000707641 | 0.00015927 | −0.00027981 | 6.11435E−05 |
| S9 | −10 | −0.004913619 | 0.001086606 | −0.000266924 | 6.38373E−05 |
| S10 | −10 | 0.014759426 | −0.002550968 | 0.000506989 | 6.70026E−06 |
| S11 | −10 | 0.002675274 | −0.001643119 | 0.000273709 | −3.0913E−05 |
| S12 | −10 | 0.010458862 | −0.003739286 | 0.000683367 | −9.00786E−05 |
| S13 | −10 | −0.000838402 | 0.000648401 | −0.000213366 | 1.05049E−05 |
| S14 | −10 | −0.003230029 | 0.000280178 | −0.000208656 | 2.22735E−05 |
| S15 | −10 | 0.000748968 | −0.001919045 | 0.000411428 | −4.79298E−05 |
| S16 | −10 | −0.004313144 | −0.000375876 | 0.000140893 | −1.53963E−05 |

Table 16 below lists focal lengths of the first to sixth or seventh lenses of the imaging lens systems according to the first to fifth embodiments.

TABLE 16

| | 1st | 2nd | 3rd | 4th | 5th |
|---|---|---|---|---|---|
| | Embodi- | Embodi- | Embodi- | Embodi- | Embodi- |
| | ment | ment | ment | ment | ment |
| f1 | 41.409 | 39.191 | 37.183 | 33.268 | 58.837 |
| f2 | 14.583 | 14.939 | 15.026 | 14.121 | 14.127 |
| f3 | 16.371 | 17.970 | 18.292 | 12.279 | 8.924 |
| f4 | −5.469 | −5.684 | −5.233 | −4.767 | −3.980 |
| f5 | 5.719 | 5.565 | 4.939 | −48.263 | −36.388 |
| f6 | −7.150 | −7.405 | −7.326 | 6.244 | 5.384 |
| f7 | — | — | — | −9.253 | −9.320 |

According to the examples of the first to fifth embodiments, the imaging lens system according to the present disclosure may have unique lens characteristics. For example, a focal length of the first lens may be within a range of 30 mm to 70 mm, a focal length of the second lens may be within a range of 12.0 mm to 18.0 mm, a focal length of the third lens may be within a range of 8.0 mm to 20 mm, a focal length of the fourth lens may be within a range of −3.0 mm to −8.0 mm, a focal length of the fifth lens may be within a range of 4.0 mm to 6.0 mm or less than −30 mm, a focal length of the sixth lens may be within a range of 4.0 mm to 8.0 mm or −10 mm to −6.0 mm, and a focal length of the seventh lens may be within a range of −12 mm to −8.0 mm.

Tables 17 and 18 below list conditional expression values of the imaging lens systems according to the first to fifth embodiments.

TABLE 17

| | 1st | 2nd | 3rd | 4th | 5th |
|---|---|---|---|---|---|
| | Embodi- | Embodi- | Embodi- | Embodi- | Embodi- |
| | ment | ment | ment | ment | ment |
| fPF/fPR | 2.8396 | 2.6234 | 2.4745 | 2.3559 | 4.1648 |
| G1L/GL | 0.4362 | 0.4542 | 0.4860 | 0.5113 | 0.4681 |
| BFL/GL | 0.4115 | 0.4404 | 0.5626 | 0.4366 | 0.4177 |
| DG12/Gfm | 3.4012 | 5.0587 | 1.6587 | 3.0987 | 3.6357 |
| ML/R1 | 0.3483 | 0.3174 | 0.3359 | 0.2382 | 0.1769 |
| \|ML/R4\| | 0.4202 | 0.4132 | 0.4241 | 0.4796 | 0.5112 |
| G1L/Dp | 2.4765 | 2.4840 | 2.5175 | 2.7529 | 2.6601 |
| Mf | 1.5473 | 1.5452 | 1.5545 | 1.6592 | 1.5131 |

TABLE 18

| | 1st | 2nd | 3rd | 4th | 5th |
|---|---|---|---|---|---|
| | Embodi- | Embodi- | Embodi- | Embodi- | Embodi- |
| | ment | ment | ment | ment | ment |
| f1/f | 2.2249 | 2.1058 | 1.9979 | 1.7875 | 3.1615 |
| f3/f | 0.8796 | 0.9655 | 0.9829 | 0.6598 | 0.4795 |
| f4/f | −0.2939 | −0.3054 | −0.2812 | −0.2562 | −0.2139 |
| \|f6/f\| | 0.3841 | 0.3979 | 0.3937 | 0.3355 | 0.2893 |
| f1/f2 | 2.8396 | 2.6234 | 2.4745 | 2.3559 | 4.1648 |
| BFL/f | 0.3728 | 0.3844 | 0.4650 | 0.3751 | 0.3787 |
| D12/f | 0.2794 | 0.2794 | 0.2794 | 0.3063 | 0.2794 |
| f3/fR | −2.2898 | −2.4266 | −2.4968 | −1.3270 | −0.9575 |

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging lens system comprising:
a first lens group comprising one or more lenses and an optical path converter; and
a second lens group comprising one or more lenses and configured to be movable in an optical axis direction,
wherein the first lens group and the second lens group are sequentially disposed in ascending numerical order along an optical axis of the imaging lens system from an object side of the imaging lens system toward an imaging plane of the imaging lens system, and
the imaging lens system satisfies the following conditional expression:
$$1.5 \leq fPF / fPR \leq 6.50$$
where fPF is a focal length of a front lens of the first lens group disposed closest to an object side of the optical path converter, and fPR is a focal length of a rear lens of the first lens group disposed closest to an image side of the optical path converter.

2. The imaging lens system of claim 1, wherein the front lens of the first lens group has a convex object-side surface in a paraxial region thereof.

3. The imaging lens system of claim 1, wherein the rear lens of the first lens group has a convex image-side surface in a paraxial region thereof.

4. The imaging lens system of claim 1, wherein a frontmost lens of the second lens group disposed closest to an image side of the rear lens of the first lens group has a convex image-side surface in a paraxial region thereof.

5. The imaging lens system of claim 1, wherein a rearmost lens of the second lens group disposed closest to the imaging plane has a concave object-side surface in a paraxial region thereof.

6. The imaging lens system of claim 1, wherein a rearmost lens of the second lens group disposed closest to the imaging plane has a concave image-side surface in a paraxial region thereof.

7. The imaging lens system of claim 1, wherein optical path converter comprises a reflecting surface, and
the imaging lens system further satisfies the following conditional expression:
$$0.5 \leq ML / R 1 \leq 0.60$$
where ML is a distance along the optical axis from the reflecting surface of the optical path converter to an image-side surface of the rear lens of the first lens group, and R1 is a radius of curvature of an object-side surface of the front lens of the first lens group.

8. The imaging lens system of claim 1, wherein the optical path converter comprises a reflecting surface, and
the imaging lens system further satisfies the following conditional expression:
$$0.2 \leq \vert ML / R 4 \vert \leq 1. 0$$
where ML is a distance along the optical axis from the reflecting surface of the optical path converter to an image-side surface of the rear lens of the first lens group, and R4 is a radius of curvature of the image-side surface of the rear lens of the first lens group.

9. An imaging lens system comprising:
a first lens, an optical path converter, a second lens having a convex image-side surface in a paraxial region thereof, a third lens, a fourth lens, a fifth lens, and a sixth lens sequentially disposed in the order listed along an optical axis of the imaging lens system from an object side of the imaging lens system toward an imaging plane of the imaging lens system,
wherein the imaging lens system satisfies the following conditional expression:
$$1.6 < f 1 / f < 3.60$$
where f is a focal length of the imaging lens system when the imaging lens system is focused on an object at infinity, and f1 is a focal length of the first lens.

10. The imaging lens system of claim 9, wherein the first lens has a convex object-side surface in a paraxial region thereof.

11. The imaging lens system of claim 9, wherein the first lens has a concave image-side surface in a paraxial region thereof.

12. The imaging lens system of claim 9, wherein the second lens has a convex image-side surface in a paraxial region thereof.

13. The imaging lens system of claim 9, wherein the third lens has a convex image-side surface in a paraxial region thereof.

14. The imaging lens system of claim 9, wherein the fourth lens has a concave object-side surface in a paraxial region thereof.

15. The imaging lens system of claim 9, wherein the fourth lens has a concave image-side surface in a paraxial region thereof.

16. The imaging lens system of claim 9, wherein the fifth lens has a convex object-side surface in a paraxial region thereof.

17. An imaging lens system comprising:
a first lens having a positive refractive power and a convex object-side surface in a paraxial region thereof;
an optical path converter;
a second lens having a positive refractive power and a convex image-side surface in a paraxial region thereof;
a third lens having a refractive power and a concave object-side surface in a paraxial region thereof;
a fourth lens having a refractive power;
a fifth lens having a refractive power; and
a sixth lens having a refractive power and a concave image-side surface in a paraxial region thereof,
wherein the first lens, the optical path converter, the second lens, the third lens, the fourth lens, the fifth lens, and the sixth lens are sequentially disposed in the order listed along an optical axis of the imaging lens system from an object side of the imaging lens system toward an imaging plane of the imaging lens system,
the first to sixth lenses each have a single refractive index and are the only lenses having a refractive power in the imaging lens system,
the third to sixth lenses are spaced apart from each other along the optical axis,
the first lens, the optical path converter, and the second lens are included in a first lens group, and
the third to sixth lenses are included in a second lens group configured to be movable along the optical axis to adjust a focus of the imaging lens system, or the third and fourth lenses are included in a second lens group configured to be movable along the optical axis to adjust the focus of the imaging lens system and the fifth and sixth lenses are included in a third lens group, or the third and fourth lenses are included in a second lens group and the fifth and sixth lenses are included in a third lens group configured to be movable along the optical axis to adjust the focus of the imaging lens system.

18. The imaging lens system of claim 17, wherein the second lens has a flat object-side surface joined with an image-side surface of the optical path converter.

19. The imaging lens system of claim 17, wherein the first lens group is configured to be rotatable about an axis perpendicular to the optical axis to perform image stabilization.

20. The imaging lens system of claim 17, wherein the optical path converter comprises a reflecting surface, and
the imaging lens system satisfies the following conditional expression:
$$1. \leq G 1 L / Dp \leq 4.0$$
where G1L is a distance along the optical axis from the object-side surface of the first lens to the image-side surface of the second lens, and Dp is a diagonal length of the reflecting surface of the optical path converter.

21. The imaging lens system of claim 17, wherein the imaging lens system satisfies the following conditional expression:
$$1.5 \leq fPF / fPR \leq 6.50$$
where fPF is a focal length of the first lens, and fPR is a focal length of the second lens.

22. The imaging lens system of claim 17, wherein the imaging lens system satisfies the following conditional expression:
$$1.6 < f 1 / f < 3.60$$
where f is a focal length of the imaging lens system when the imaging lens system is focused on an object at infinity, and f1 is a focal length of the first lens.

23. An imaging lens system comprising:
a first lens having a positive refractive power and a convex object-side surface in a paraxial region thereof;
an optical path converter;
a second lens having a positive refractive power and a convex image-side surface in a paraxial region thereof;
a third lens having a refractive power and a convex object-side surface in a paraxial region thereof;
a fourth lens having a refractive power;
a fifth lens having a refractive power;
a sixth lens having a refractive power; and
a seventh lens having a refractive power and a concave image-side surface in a paraxial region thereof,
wherein the first lens, the optical path converter, the second lens, the third lens, the fourth lens, the fifth lens, the sixth lens, and the seventh lens are sequentially disposed in the order listed along an optical axis of the imaging lens system from an object side of the imaging lens system toward an imaging plane of the imaging lens system,
the first to seventh lenses each have a single refractive index and are the only lenses having a refractive power in the imaging lens system,
the third to seventh lenses are spaced apart from each other along the optical axis,
the first lens, the optical path converter, and the second lens are included in a first lens group, and
the third to seventh lenses are included in a second lens group configured to be movable along the optical axis to adjust a focus of the imaging lens system.

24. The imaging lens system of claim 23, wherein the second lens has a flat object-side surface joined with an image-side surface of the optical path converter.

25. The imaging lens system of claim 23, wherein the first lens group is configured to be rotatable about an axis perpendicular to the optical axis to perform image stabilization.

26. The imaging lens system of claim 23, wherein the optical path converter comprises a reflecting surface, and
the imaging lens system satisfies the following conditional expression:
$$1. \leq G 1 L / Dp \leq 4.0$$
where G1L is a distance along the optical axis from the object-side surface of the first lens to the image-side surface of the second lens, and Dp is a diagonal length of the reflecting surface of the optical path converter.

27. The imaging lens system of claim 23, wherein the imaging lens system satisfies the following conditional expression:
$$1.5 \leq fPF / fPR \leq 6.50$$
where fPF is a focal length of the first lens, and fPR is a focal length of the second lens.

28. The imaging lens system of claim 23, wherein the imaging lens system satisfies the following conditional expression:
$$1.6 < f 1 / f < 3.60$$
where f is a focal length of the imaging lens system when the imaging lens system is focused on an object at infinity, and f1 is a focal length of the first lens.
